(19) United States
(12) Patent Application Publication
(10) Pub. No.: US 2005/0240341 A1
(43) Pub. Date: Oct. 27, 2005

(54) Low-power photonic telemetry system and method for spacecraft monitoring

(76) Inventors: Karl B. Fielhauer, Clarksville, MD (US); Bradley G. Boone, Columbia, MD (US)

Correspondence Address: APPLIED PHYSICS LABORATORY;THE JOHNS HOPKINS UNIVERSITY, OFFICE OF PATENT COUNSEL, 11100 JOHNS HOPKINS ROAD, LAUREL, MD, 20723-6099, US

(21) Appl. No.: 10/979,697

(22) Filed: Nov. 2, 2004

Related U.S. Application Data
(60) Provisional application No. 60/516,780, filed on Nov. 3, 2003.

(51) Int. Cl. B64D 3/00

(52) U.S. Cl. 701/200; 244/3

(57) ABSTRACT

An optical telemetry system and method for monitoring the location and status of a spacecraft (e.g., a satellite, a missile, a manned vehicle, etc.) using an optical communication link in an extraterrestrial environment. The system is optimally suited for monitoring the status and location of the spacecraft during a separation procedure of a spacecraft from its launch vehicle and uses a low-power optical communication link between a support craft and a spacecraft to obtain data. The data is then processed by the support craft and relayed to sources external to the support craft using the launch vehicle's telemetry system. Moreover, the system and method can also be used to monitor the status and location of an array (e.g., a three-dimensional array) of space vehicles traveling in space (e.g., an array of satellites).

### CROSS-REFERENCE TO RELATED APPLICATIONS

This application claims the benefit of prior filed co-pending U.S. application No. 60/516,780, filed on Nov. 3, 2003, the contents of which are incorporated herein by reference.

### STATEMENT OF GOVERNMENTAL INTEREST

This invention was made with Government support under Contract No. NAS5-97271, awarded by the National Aeronautics and Space Administration (“NASA”). The Government has certain rights in the invention.

### BACKGROUND OF THE INVENTION

1. Field of the Invention

The present invention relates to an apparatus and method for monitoring spacecraft location and status using an optical communication link in an extraterrestrial environment, and more particularly to an apparatus and method for monitoring the status and location of a spacecraft during separation from its launch vehicle using a low-power optical communication link to obtain data and then relaying the data using an existing launch vehicle telemetry system as a relay.

2. Description of Related Art

Spacecraft telemetry systems have been used to provide necessary data relating to the location and status of spacecraft, their cargo and passengers since the beginning of space travel. Recently, after the destruction of several spacecraft in flight, it has become more desirable to monitor the status and location of spacecraft at all critical times. Because of design, time, space, weight and cost restraints, neither redesigning nor updating existing telemetry systems to monitor spacecraft is always feasible or possible.

To further complicate the telemetry problem, the frequency and number of upcoming launches of space vehicles is increasing.

For these and other reasons, NASA has directed the MESSENGER (MErcury Surface, Space ENvironment, GEochemistry, and Ranging) program to provide near real-time telemetry during third-stage separation. Other NASA missions are also being tasked with similar requirements, including JPL's (Jet Propulsion Laboratory) Mars Reconnaissance Observer (MRO). In the wake of the Challenger, Columbia, CONTOUR (COmet Nucleus TOUR), TIMED (Thermosphere Ionosphere Mesosphere Energetics and Dynamics) and Mars mission mishaps, critical event monitoring will likely be mandatory for all future space missions. Launch vehicle separation and other significant events will have to be monitored by a ground station. Moreover, as the dates and times of interplanetary missions are target driven, and as event-driven telemetry systems can add significant cost to space missions, a more flexible telemetry architecture must be considered for interplanetary and event-driven launches.

To further complicate matters, spacecraft autonomy rules or mission design may prevent turn-on of spacecraft radio frequency (RF) transmitters at separation due to battery charge state and solar array deployment status. In addition, the spacecraft may not have adequate link margin or may be tumbling too quickly under certain scenarios for RF telemetry to be received. Furthermore, missions requiring constellations of spacecraft (nanosats) may not have an adequate number of ground assets to query all spacecraft during an initial pass. Thus there is a need to provide a system that requires little power draw and emits minimal RF.

During separation, spacecraft are permitted to radiate RF and/or other electromagnetic radiation inside the spacecraft's fairing, provided that the emissions do not exceed the maximum level deemed safe for launch vehicle avionics and ordnance circuits. However, the design of two RF systems: an S-Band system for separation and early operation, e.g., tracking and data relay satellite system (TDRSS), and another X-Band or Ka-Band system needed to support the mission, may not be practical or possible for all missions. Thus there is a need for a telemetry system design that will be more practical than a dedicated RF system.

There is also a need for a telemetry system that can provide needed data, e.g. to a ground crew or other stationary receiver, during critical routines such as docking and other maneuvers.

### SUMMARY OF THE INVENTION

It is therefore a feature of the present invention to provide a multi-platform optical telemetry unit.

It is another feature of the present invention to provide a small-sized, low-power, high-bandwidth photonic telemetry system and method that is compatible with wireless, infra-red (IR) busses, and extensible to pre-launch built in test (BIT) and ISS (International Space Station) BIT, and can be made secure using micro-electro-mechanical systems (MEMS) beam-steering, signal encoding, and wavelength division multiplexing.

It is a further feature of the present invention to provide a low power photonic telemetry system as an add-on launch service thereby standardizing the approach and interface.

It is yet another feature of the present invention to provide a telemetry system and method that does not produce significant RF and uses little power so that it is independent of battery charge state and can be used during the separation of a spacecraft from its launch vehicle, and which would not interfere with existing launch vehicle telemetry and beacon systems.

It is still yet a further feature of the present invention to provide a telemetry system and method with a sufficient link state so that the system can monitor tumbling spacecraft which could otherwise not be sufficiently monitored by RF transmitter/receiver pairs.

It is yet another feature of the present invention to provide efficient opto-coupled capability for pre-launch BIT on the ground, either during assembly or just prior to launch, to allow more efficient and timely integration and preflight checkout.

To achieve the above features, there is provided in one embodiment an optical telemetry system for determining the location of one or more space vehicles comprising at least one optical source for providing a plurality of optical signals for interrogation, the optical source being mounted upon a first vehicle; at least one spatial light modulator (SLM) transponder for receiving, modulating and retransmitting the optical signals for interrogation, the at least one SLM being mounted upon a second vehicle; and a receiver for receiving the modulated and retransmitted optical signals for interrogation, the receiver being mounted upon the second vehicle, wherein the location of one or more space vehicles is determined by analyzing the retransmitted optical signals.

In accordance with a second embodiment of the present invention, an optical communication system for relaying data is provided comprising an optical transponder for transmitting an interrogation beam and receiving a retransmitted interrogation beam, the optical transponder being mounted on a first vehicle; and a spatial light modulator (SLM) transponder for receiving the interrogation beam, adding data to the interrogation beam and retransmitting the interrogation beam, the SLM transponder being mounted on a second vehicle; wherein the first vehicle obtains status and location information of the second vehicle from the retransmitted interrogation beam.

In accordance with a third embodiment of the present invention, an optical telemetry system for space vehicles is provided comprising an optical source for providing an optical signal for interrogation, the optical source being mounted on a first vehicle; a receiver for receiving the optical signal, the receiver being mounted on a second vehicle; a modulator coupled to the receiver for modulating the received optical signal; a transmitter coupled to the receiver for transmitting the modulated optical signal; and a receiving device for receiving the modulated optical signal, the receiving device being mounted on the second vehicle.

In accordance with a fourth embodiment of the present invention, a method for obtaining data including location and status of a vehicle is provided comprising querying a first vehicle from a second vehicle using an interrogating beam; modulating the interrogating beam so that it contains information about the first vehicle and re-radiating the modulated interrogating beam; and receiving and demodulating by the second vehicle the modulated interrogating beam.

### BRIEF DESCRIPTION OF THE DRAWINGS

The above and other objects, features and advantages of the present invention will become more apparent from the following detailed description when taken in conjunction with the accompanying drawings, in which:

FIG. 1 illustrates an optical spacecraft telemetry system according to an embodiment of the present invention;

FIGS. 2A and 2B illustrate the operation of a spatial light modulator (SLM) transponder which is queried by a DC interrogation beam according to an embodiment of the present invention;

FIG. 3 is a side view illustration of an SLM transponder according to an embodiment of the present invention;

FIG. 4 is a block diagram illustrating the internal S/C telemetry bus according to an embodiment of the present invention;

FIG. 5 is an illustration showing an embodiment of the photonic spacecraft architecture according to an embodiment of the present invention;

FIG. 6 is a graph illustrating preliminary bit error rate calculations based on a limited SLM bandwidth between 1 and 10 kHz and showing BER versus range for a modulated (spoiled) beam using on-off-keying (OOK);

FIG. 7 is a graph illustrating SNR (dB) vs. range, according to an embodiment of the present invention;

FIG. 8 is an illustration of a photonic telemetry system for a plurality of microsats positioned in a three dimensional array, according to an embodiment of the present invention; and

FIG. 9 illustrates an optical spacecraft telemetry system for a cluster of microsats according to an embodiment of the present invention.

### DESCRIPTION OF THE PREFERRED EMBODIMENTS

The following detailed description of the preferred embodiments of the present invention will be made with reference to the accompanying drawings. In describing the invention, explanations about related functions or constructions which are known in the art will be omitted for the sake of clarity in understanding the concept of the invention.

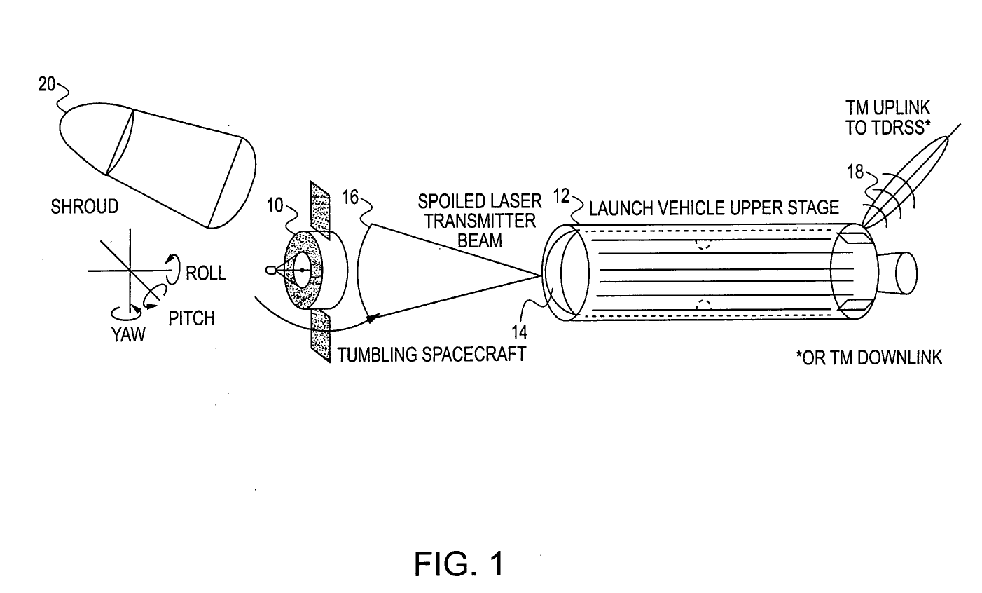

A diagram illustrating an optical spacecraft telemetry system according to one embodiment of the present invention is shown generally in FIG. 1. A spacecraft (e.g., a satellite) 10 is launched into space using a launch vehicle. The launch vehicle includes one or more stages. In the embodiment shown, the launch vehicle includes upper and lower stages. The lower stages are expended during various stages of the launch and are not shown. The spacecraft 10 is attached to the upper stage of its launch vehicle 12. An optional shroud 20 is releasably attached to the launch vehicle and acts to enhance the aerodynamics of the combination formed by the spacecraft 10 and the launch vehicle including the upper stage 12, and to protect the spacecraft 10. Once the shroud 20 is no longer necessary, it is jettisoned as shown. During separation of the spacecraft 10 from the launch vehicle upper stage 12, a spoiled laser transponder 14 emits a spoiled laser beam (e.g., a beam which is also known as an interrogation or interrogator beam) 16 which is incident upon the spacecraft 10. Suitable lasers for producing an interrogation beam include continuous wave (CW) laser having a infrared frequency laser. One or more transponders (e.g., SLM transponders or other suitable transponders which are not shown) mounted on the spacecraft 10 modulate and return the interrogator beam to the launch vehicle upper stage 12. The launch vehicle upper stage 12 then processes the received interrogator beam to obtain necessary data, which can include data which is found in a spacecraft telemetry frame (e.g., acceleration, spacecraft status, etc.) and transmits this data using a telemetry (TM) uplink to TDRSS 18 to a recipient. In other embodiments of the present invention the telemetry system is active during ascent, separation, and/or post-separation periods to monitor the spacecraft performance.

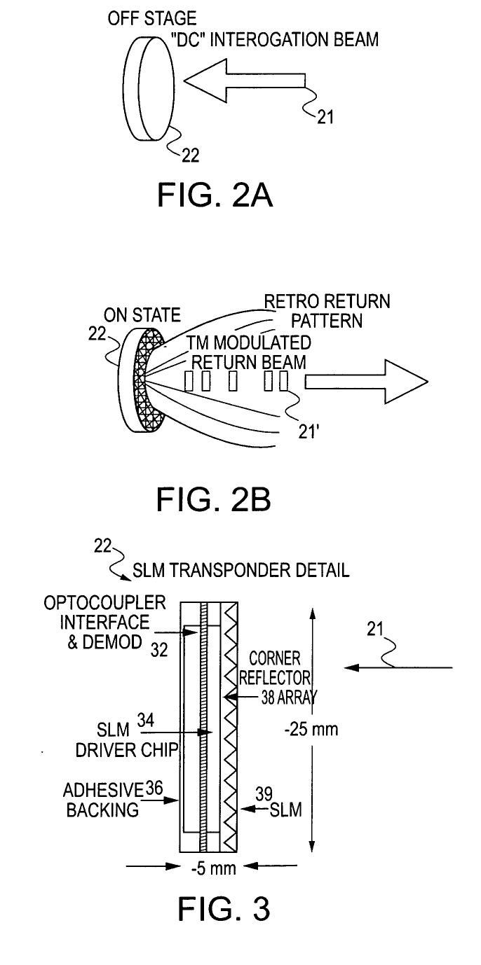

An illustration of the operation of an SLM transponder in the off state which is queried by a DC interrogation beam according to an embodiment of the present invention is shown in FIG. 2A. The SLM transponder 22 can alter its transparency using a polarizing LCD layer which is used to modulate an incident light beam 21 (which is similar to the spoiled laser transmitter beam 16 shown in FIG. 1), and includes a plurality of corner reflectors (not shown, which form a retro-reflective array) to reflect the selectively modulated incident light beam so that it can be received and processed (e.g., demodulated, etc.) by an optical receiver (not shown). A reflected light beam is optionally returned in the same direction from which it was received, but in alternative embodiments, can be reflected in one or more desired directions as will be described below. The SLM transponder 22 is shown in the off state wherein a DC interrogation beam 21 incident upon the SLM transponder 22 during the off state is substantially attenuated, while a DC interrogation beam 21 which is incident upon a the SLM transponder 22 in the on-state is returned with minimal attenuation. By modulating the on-off states of the SLM transponder 22, incident interrogation beam 21 can be modulated. Suitable SLM transponders include Commercial Off-The-Shelf (COTS)-based liquid crystal LCD SLM's. Furthermore, COTS-based MEMS micrometer arrays can be used to control micro-mirrors (e.g., the corner-reflector mirrors as will be described below) for tracking the return signal on the launch vehicle side, and modulate the signal on the spacecraft side using either pulse-position modulation (PPM) or on-off-keying (OOK) modulation or some other standard such as, for example, MIL-STD-1553, MIL-STD-1773, or RS-422 which are well known in the art.

An illustration of the operation of an SLM transponder in the on state which is queried by a DC interrogation beam according to an embodiment of the present invention is shown in FIG. 2B. The on-off state of the SLM transponder 22 is selectively cycled when a DC interrogation beam is incident upon the SLM transponder 22 so as to selectively attenuate DC interrogation beam 21. Those parts of the DC interrogation beam which are not attenuated (i.e., those parts of the DC interrogation beam 21 which are received during the on-state of the SLM transponder 22) are reflected by an array of corner-reflector mirrors and are returned as a modulated DC interrogation beam 21′ (in substantially the same direction from which they were received) to the transponder 14 for further processing.

In alternative embodiments, other optical modulators which have similar characteristics to SLM transponders can be substituted for the SLMs. Suitable SLM transponders include a modest bandwidth SLM overlaid on a retro-reflective array (e.g., a corner reflector array). Currently available SLMs using single pixel devices (shutters) have bandwidths up to 10 kHz but have a limited temperature range of operation. Both of these parameters are critical and must be carefully evaluated with consideration given to the conditions the spacecraft will be exposed to in space. Other suitable SLMs include ferroelectric and nematic liquid crystal devices. Other suitable technologies include MEMS or polymer-based SLMs.

If required, multiple point-object image tracking algorithms can be used to acquire and track the corner transponders, if it were deemed necessary or beneficial for the link or if requirements demand it.

Suitable modulation schemes include OOK, M-ary PPM, AM phase-sensitive detection and coded pulse train modulation schemes. In alternative embodiments, other suitable modulation schemes which are known in the art and which are suitable with the technology used in the system can be used as desired.

A side view illustration of an SLM transponder according to an embodiment of the present invention is shown in FIG. 3. The SLM transponder 22, includes an SLM layer 39, a retro-reflective array (e.g., a corner reflector array) 38, an optocoupler interface and demodulator 32, an SLM driver chip 34 and an adhesive backing 36. The SLM layer 39 is the physical medium that is used to attenuate an incident light beam 21. The retro-reflective array 38 as described above is used to reflect and return an incident light beam 21 to the source (not shown) of the incident light beam 21. The optocoupler interface and demodulator 32 is used for providing a control signal which controls the transmittance of the SLM layer (for modulating light), to the SLM transponder 22. The SLM driver chip 34 is used for controlling the modulator 32 and the optional controllable corner reflector array 38. The adhesive backing 36 is used for mounting the SLM transponder 22 to a suitable surface. Suitable adhesive backings include, but are not limited to, pressure sensitive adhesives, epoxies, and the like.

The SLM transponder is driven by a controller (not shown) which is used for controlling the on-off states of the SLM transponder. The controller is optionally built integrally with the SLM transponder. In alternative embodiments, the controller is coupled with the SLM transponder but is not integral with the SLM transponder. In yet other alternative embodiments, the controller can control a plurality of SLM transponders.

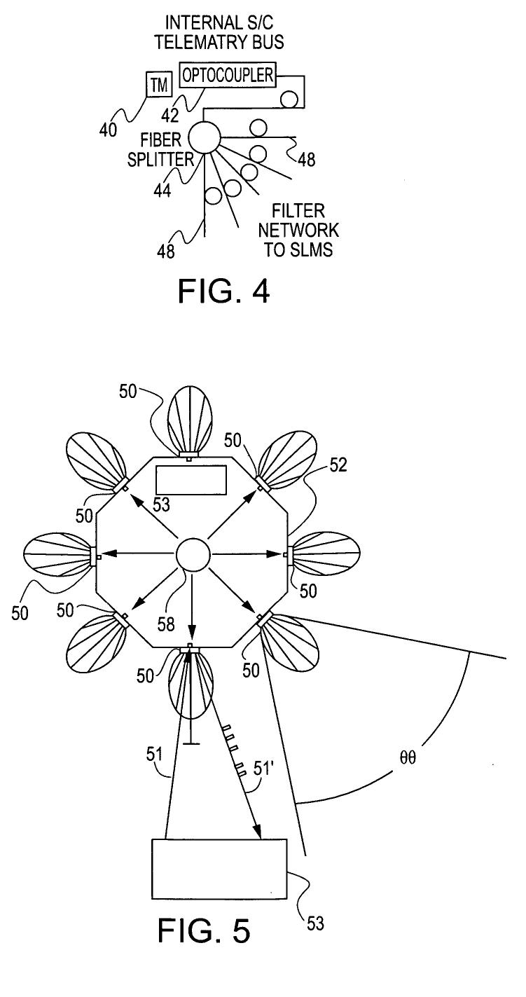

A block diagram illustrating the internal spacecraft (S/C) telemetry bus according to an embodiment of the present invention is shown in FIG. 4. S/C telemetry bus includes an S/C on-board telemetry system 40 which provides telemetry data, an optocoupler 42, a fiber splitter 44 and a plurality of SLM transponders 46. The internal S/C telemetry bus couples the S/C on-board telemetry system 40 to the SLM transponder 46, so that information (e.g., normal spacecraft telemetry data including spacecraft i.d., acceleration, etc.) and other data can be relayed from the S/C on-board telemetry system 40 to the SLM transponder and, so that, an incident interrogation beam can be appropriately modulated by the SLM transponder 46. The plurality of SLM transponders 46 are coupled to the fiber splitter 44 via a plurality of fiber optic lines 48. In use, the S/C on-board telemetry system 40 sends one or more signals (containing data, etc.) to the optocoupler 42 which then transfers these signals to the plurality of SLM's via the optional fiber splitter 44. In alternative embodiments of the present invention, free space coupling could be used when appropriate. For example, rather than using fiber optic lines to transmit optical signals, a free space transmission system can be used.

The present embodiment illustrates a uni-directional communication scheme wherein a first vehicle queries a second vehicle to obtain data about the second vehicle. In alternative embodiments, a bi-directional communication scheme can be employed, wherein both the first vehicle and the second vehicle can query each other and send data to each other.

An illustration showing an embodiment of the photonic spacecraft architecture according to an embodiment of the present invention is shown in FIG. 5. A plurality of SLM transponders 50 are mounted upon a spacecraft 52. An internal S/C telemetry bus 54 is coupled to an optocoupler 56 which is coupled to a light distribution box 58 (which is similar to the fiber splitter 44 as described in FIG. 4). In operation, the internal S/C telemetry bus 54 controls the SLM transponders 50 by sending control commands to the plurality of SLM transponders 50 via the optocoupler 56 and light distribution box 58. By using a plurality of SLM transponders, tumbling spacecraft can be more readily queried as the probability of an SLM transmitter within the line of sight (LOS) of an incoming interrogation beam increases. Moreover, the use of a plurality of SLM transponders on a first spacecraft enables a plurality of spacecraft, located in various locations relative to the first spacecraft, to query the first spacecraft.

The operation of an individual SLM transponder 50 will now be described in more detail. In use, a querying vehicle 53 emits a DC interrogation beam 51 which is incident upon an SLM transponder 50 which is mounted on the spacecraft 52. The transponder receives signals from the internal S/C telemetry bus 54 and modulates the incident DC interrogation beam 51, turning it into a TM modulated return beam 51′ as shown. The SLM transponders have usable range θθ as shown. For example, a DC interrogation beam incident upon the surface of the SLM transponder at a given angle would be returned at substantially the same angle with slight dispersion. The operation of the other SLM transponders is similar. This embodiment illustrates that the spacecraft's omni-directional beam coverage can be traded off with TM signal redundancy. For example, if a full 4π Steradian coverage is desired, then the number of SLM transponders can be increased to accommodate this, otherwise fewer SLM transponders can be used. Because the optical system on many deployed spacecraft (e.g., multiple optoelectronic transponder buttons on the spacecraft skin) can be the same for many different types of spacecraft, the optical telemetry system of the present invention can be easily installed upon these spacecraft.

The present invention can also be used for systems including photonic telemetry, manipulating systems, evolvable and morphing structures, and on-orbit docking and self assembly systems. Moreover, the present invention can be stacked and easily upgraded. Moreover, photonic telemetry can be used for the identification, friend or foe (IFF). An additional benefit of photonic telemetry is low power usage. Additionally, photonic telemetry is insensitive to ground station location and to potential spacecraft tumbling (i.e., roll, pitch and yaw motions).

As the optical transmitter and receiver system of the present invention is a secondary payload to the launch vehicle, it requires minimal modifications to the launch vehicle assembly. It can be connected to the normally supplied attach fitting (e.g., the spacecraft to launch vehicle interface). However, it would not be ejected by the launch vehicle at separation but connected via a fiber optic umbilical to the launch vehicle telemetry system. Typical separation velocities are quite low, on the order of 1 m/sec, so that the optical link can be maintained over a substantial period. If a de-orbit burn is executed, additional pointing may be required (for example, via MEMS technology as discussed above), but its utility would need to be traded off with transmitter power and signal redundancy.

The optical system on the deployed spacecraft (multiple optoelectronic transponder buttons on the spacecraft skin) can be the same for various spacecraft, thus supporting a wide variety of nanosat, Low-Earth-Orbit (LEO), and deep-space missions. Intra-satellite wireless bus technology (IRCOMM) can enable an interface between the spacecraft internal telemetry bus and the external spacecraft skin without the imposition of an additional wiring harness to all transponder buttons. These transponders would employ SLM retro-reflective arrays to provide large angle tolerance to an interrogating laser beam (≈3 dB over 20°), thus returning the modulated laser beam back to the launch vehicle, albeit with an R⁴ loss rather than an R² loss (where R indicates distance), but also tolerating a significant portion of the tumble dynamics.

There are several variables which have to be considered in designing a useful photonic telemetry system for the separation maneuver application. These include a trade-off in beam-width with range for a given link margin at telemetry bandwidths. As part of this tradeoff, R^{4th} losses, retro-reflector area and attitude with respect to the line-of-sight, and SLM throughput must be considered in any calculations. Also, the trade-off between partial 4π Steradian retro-reflector coverage versus telemetry signal redundancy must be considered.

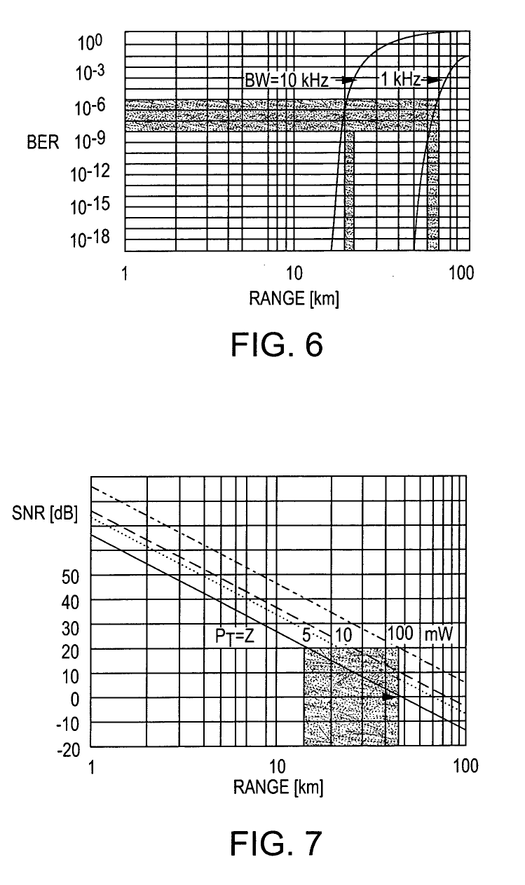

A graph illustrating preliminary bit error rate (BER) calculations based on a limited SLM bandwidth between 1 and 10 kHz and showing BER versus range for a modulated (spoiled) beam using OOK is shown in FIG. 6. The shaded areas indicate an expected area of operation. From the graph, it is seen that it can be possible to recover telemetry data having a sufficiently low bandwidth of 1 kHz, using a spoiled beam (emitted from a laser having only 1 mW of power) from a spacecraft at a distance in excess of 60 km from the launch vehicle.

A graph illustrating SNR (dB) vs. range is shown in FIG. 7. It is seen that increasing transmitter power by a factor of 20 dB up to 100 mW improves range (as gauged by a conservative threshold SNR of 20 dB) by a factor of 6 dB to over 40 km. The shaded area indicates an expected area of operation. As a 100 mW laser diode is not much larger in size than a 1 mW laser diode, it can be supported by a launch vehicle with minimal additional impact.

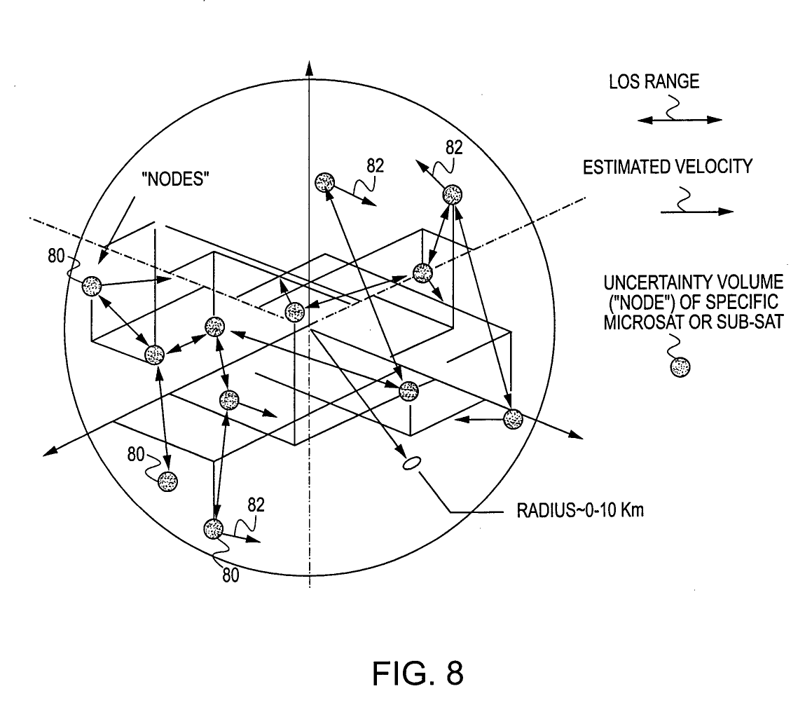

An illustration of a photonic telemetry system for a microsat cluster in operating space according to an embodiment of the present invention is shown in FIG. 8. A plurality of microsats (i.e., small spacecraft) 80 are positioned in three dimensional space. The microsats should remain in the line of sight (LOS) of each other (i.e., they should remain within the optical range of the telemetry system of the present invention). It is preferred that more than five microsats 80 be used. The photonic telemetry system can be used for relative navigation and guidance of the microsats 80. For example, for a sufficient number (i.e., greater than 5) of spacecraft nodes (i.e., microsats), relative navigation solution of position (shown) and velocity in three dimensions can be ascertained using only line-of-sight range measurements between nodes. Velocity estimates can be developed from successive range samples. Velocity vectors 82 are shown for illustration. Additionally, angle information can be supplied based on microsat 80 attitude and limited optical link beamwidths. Moreover, the optical link can be uni-directional or can be bi-directional. Multimode modulation allows for multiple functionality. For example, in Table 1 different modulation schemes are shown with various functional modes.

TABLE 1

| Modulation Scheme | Functional Mode |
|---|---|
| M-ary PPM | Comms |
| AM phase sensitive detection | Ranging |
| Coded-pulse train | Authentication |

Depending upon the desired level of complexity, different photonic telemetry options can be used. For example, a transponder link with a spoiled beamwidth and no tracking is the simplest photonic telemetry system, and can be used for command and data handling and provides identification, friend or foe (IFF) capability. By increasing the system complexity, a full duplex link with spoiled beamwidth and no tracking can be used to add a range-only track file with velocity estimates for netted navigation. The most complex system of all is a full duplex link with MEMS beam-steering and selective field of view (FOV) which adds fully autonomous navigation and enhanced IFF.

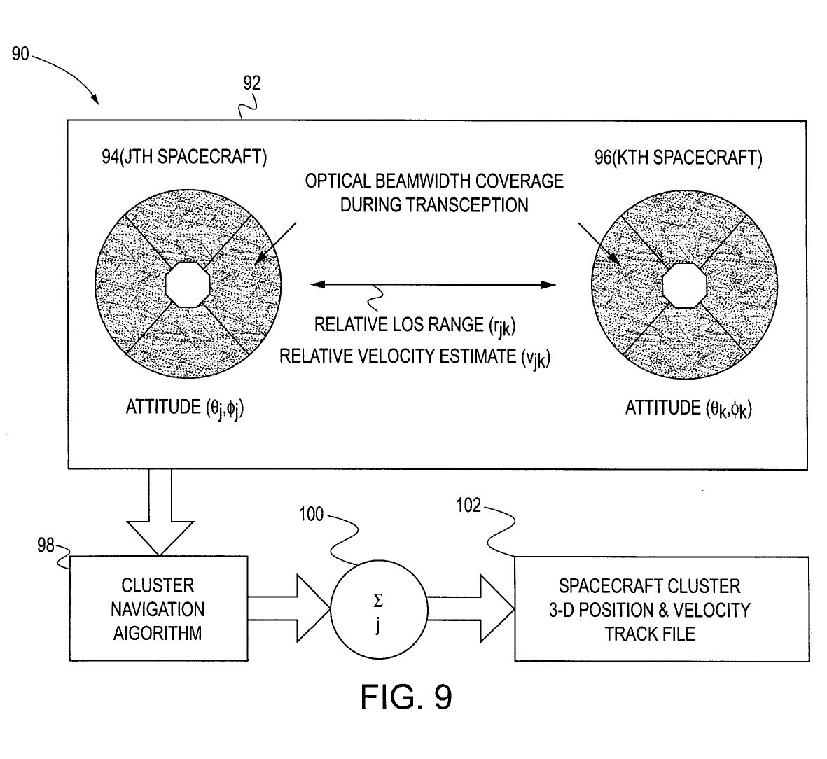

A block diagram illustrating relative navigation and guidance operations for the photonic telemetry system including a microsat cluster, according to an embodiment of the present invention is shown in FIG. 9. The system 90 includes a plurality of microsats (i.e., preferably more than 5 small specific-use spacecraft) positioned in three dimensional space 92 with at least one craft having a spoiled laser transponder and at least a second craft having at least one or more SLM transponders. For illustration, only two microsats are shown. Both microsats, e.g., the j^{th} microsat 94 and the k^{th} microsat 96, are within relative line of sight (LOS) range of each other. A plurality of queries are used to obtain data on at least one of the microsats relative to the other. For example, this data can include a relative LOS range rⱼₖ, and a relative velocity estimate vⱼₖ between the jₜₕ microsat 94 and the k^{th} micosat 96. Data is processed by the cluster navigation algorithm 98 and transferred to a summer 100 and stored for future use in a spacecraft cluster 3-D position and velocity track file 102. Thus, the present invention can use received range, range rate, angle data, etc. (which is transmitted by the spacecraft's SLM transponder) to determine the position of one or more spacecraft. In alternative embodiments, the position of one or more spacecraft can be determined by analyzing the returned beam itself (e.g., for time delay, etc.) to determine the position of the spacecraft. For example, by measuring the time delay between the transmission of an interrogation beam and its reception as a modulated beam, the range of a spacecraft can be determined. Moreover, by querying for range a plurality of times, the velocity of a spacecraft can be determined.

While the present invention has been described with detail according to a spacecraft separating from its launch vehicle, the present invention can also be used for proximity operations such as relative navigation and guidance. Moreover, the present invention can be used for command and data handling for sensor netting fusion and discrimination. Furthermore, the present invention can be used for authentication including IFF. Additionally, the present invention can be used for building reconfigurable spacecraft constellations and structures. Moreover, the term spacecraft as used in this invention includes satellites, a missiles, a manned vehicles, robotic space vehicles, microsats, etc. While the above description contains many specifics, these specifics should not be construed, as limitations of the invention, but merely as exemplifications of preferred embodiments thereof. Those skilled in the art will envision many other embodiments within the scope and spirit of the invention as defined by the claims appended hereto.

1. A method for obtaining data including location and status of a vehicle comprising the steps of:
querying a first vehicle from a second vehicle using an interrogating beam;
modulating said interrogating beam so that it contains information about said first vehicle and re-radiating said modulated interrogating beam; and
receiving and demodulating by said second vehicle said modulated interrogating beam.

2. The method of claim 1, wherein said second vehicle processes said modulated interrogating beam and transmits information contained in said modulated interrogating beam using a radio frequency (RF) transmission.

3. The method of claim 2, wherein said RF transmission is received by at least one other vehicle.

4. The method of claim 2, wherein said RF transmission is received by a stationary receiver.

5. The method of claim 2, wherein said information is relayed to a plurality of vehicles.

6. The method of claim 1, wherein said first vehicle is a spacecraft.

7. The method of claim 1, wherein said information includes information relating to the roll, pitch and yaw of said vehicle.

8. The method of claim 1, wherein said information includes information relating to the acceleration of said vehicle.

9. The method of claim 1, wherein said information includes information relating to the condition of said vehicle.

10. The method of claim 1, wherein said steps of querying, modulating and receiving are repeated a plurality of times so that the location of said first vehicle can be determined.

11. The method of claim 1, wherein said steps of querying, modulating and receiving are repeated a plurality of times so that the velocity of said first vehicle can be determined.

12. The method of claim 6, wherein said second vehicle is a spacecraft.

13. The method of claim 1, wherein said step of modulating comprises amplitude modulation.

14. The method of claim 1, wherein said modulating scheme is selected from one of an on-off-keying (OOK), M-ary pulse-position modulation (PPM), AM phase-sensitive detection and a coded pulse train modulation schemes.

15. An optical telemetry system for space vehicles comprising:
an optical source for providing an optical signal for interrogation, said optical source being mounted on a first vehicle;
a receiver for receiving said optical signal, said receiver being mounted on a second vehicle;
a modulator for modulating said received optical signal;
a transmitter for transmitting said modulated optical signal; and
a receiving device for receiving said modulated optical signal, said receiving device being mounted on said first vehicle.

16. The optical telemetry system of claim 15, wherein said receiver, said modulator and said transmitter are integrally located within a spatial light modulator (SLM) transponder.

17. The optical telemetry system of claim 16, further comprising an S/C on-board telemetry system for providing a control signal to said modulator.

18. The optical telemetry system of claim 17, further comprising an optocoupler for coupling said control signal to said modulator.

19. The optical telemetry system of claim 17, wherein said transmitting device comprises a retro-reflective array for reflecting said modulated optical signal.

20. The optical telemetry system of claim 15, wherein said modulated optical signal is an AM modulated signal.

21. The optical telemetry system of claim 15, wherein said modulated optical signal is chosen from one of a one of an on-off-keying (OOK), M-ary pulse-position modulation (PPM), AM phase-sensitive detection and coded pulse train modulation schemes.

22. An optical telemetry system for determining the location of one or more space vehicles comprising:
at least one optical source for providing a plurality of optical signals for interrogation, said optical source being mounted on a first vehicle;
at least one spatial light modulator (SLM) transponder for receiving, modulating and retransmitting said optical signals for interrogation, said at least one SLM being mounted on a second vehicle; and
a receiver for receiving said modulated and retransmitted optical signals for interrogation, said receiver being mounted upon said first vehicle, wherein the location of one or more space vehicles is determined by analyzing said retransmitted optical signals.

23. The optical telemetry system of claim 22, wherein a plurality of space vehicles are located within line of sight (LOS) of each other in free space, and each receive, modulate and retransmit optical signals for interrogation from one or more adjacent space vehicles.

24. The optical telemetry system of claim 22, wherein said optical source comprises a spoiled laser.

25. The optical telemetry system of claim 22, wherein said laser comprises a 1550 nm CW laser.

26. The optical telemetry system of claim 22, wherein identification information of said one or more space vehicles is contained within at least one of said modulated and retransmitted optical signals for interrogation.

27. The optical telemetry system of claim 22, wherein said SLM transponder further includes a retro-reflective array.

28. The optical telemetry system of claim 22, wherein a plurality of said modulated and retransmitted optical signals for interrogation are used for determining line of sight (LOS) range, and velocity of individual vehicles.

29. An optical telemetry system for determining the location of a plurality of space vehicles for precisely controlling an array of spacecraft comprising:
at least one optical source for providing a plurality of optical signals for interrogation, said optical source being mounted on a first vehicle;
at least one spatial light modulator (SLM) transponder for receiving, modulating and retransmitting said optical signals for interrogation, said at least one SLM being mounted on a second vehicle;
a receiver for receiving said modulated and retransmitted optical signals for interrogation, said receiver being mounted upon said first vehicle, wherein the location of one or more space vehicles is determined by analyzing said retransmitted optical signals; and
a controller for precisely controlling the location of said plurality of space vehicles.

30. An optical communication system for relaying data comprising:
an optical transponder for transmitting an interrogation beam and receiving a retransmitted interrogation beam, said optical transponder being mounted on a first vehicle; and
a spatial light modulator (SLM) transponder for receiving said interrogation beam, adding data to said interrogation beam and retransmitting said interrogation beam, said SLM transponder being mounted on a second vehicle, wherein said first vehicle obtains status and location information of said second vehicle from said retransmitted interrogation beam.

31. The optical communication system of claim 30, wherein said second vehicle is a spacecraft.
